(19) United States
(12) Patent Application Publication
(10) Pub. No.: US 2024/0277002 A1
(43) Pub. Date: Aug. 22, 2024

(54) A METHOD FOR THE MANUFACTURE OF A FOAMING COFFEE POWDER AND COFFEE POWDER RESULTING THEREFROM

(71) Applicant: Koninklijke Douwe Egberts B.V., Utrecht (NL)

(72) Inventors: Borja Roman Corrochano, Utrecht (NL); Sian Henson, Banbury (GB); Cameron Duhig, Banbury (GB)

(21) Appl. No.: 18/571,158

(22) PCT Filed: Jun. 14, 2022
(86) PCT No.: PCT/EP2022/066229

§ 371 Date: Dec. 15, 2023

(30) Foreign Application Priority Data
Jun. 18, 2021 (GB) 2108784.6

(51) Int. Cl. A23F 5/32; A23F 5/28; A23F 5/36

(52) U.S. Cl. CPC A23F 5/32; A23F 5/285; A23F 5/36

(57) ABSTRACT

The present invention relates to a method for the manufacture of a freeze-dried coffee powder, the method comprising: (a) providing a coffee extract having from 40 wt % to 55 wt % solids: (b) high-shear mixing the coffee extract in a rotor/stator aerator with added gas to form a foamed coffee extract, the gas being added in an amount of from 1 NL/kg to 5 NL/kg of coffee extract, wherein the rotor/stator aerator is maintained at a pressure of less than 2 bar and is configured to subject the coffee extract to a shear of from 7,500 to 20,000 s⁻¹ in a single pass having a residency time of at least 1 second, (c) cooling the foamed coffee extract to below −40° C. without shear, or with low shear, to form a frozen coffee extract, (d) grinding the frozen coffee extract to a powder; and (c) drying the powder, wherein the step (c) of cooling the foamed coffee extract to below −40° C.

comprises: (i) cooling the foamed coffee extract to a first temperature; (ii) cooling the foamed coffee extract from the first temperature to a second temperature lower than the first temperature; and (iii) cooling the foamed coffee extract from the second temperature to below −40° C., wherein the first temperature is 1° C. above a freezing point of the foamed coffee extract and wherein the second temperature is 3° C. below the freezing point, wherein step (ii) has a duration of from 30 minutes to 5 hours, preferably 1 to 4 hours, and wherein the foamed coffee extract obtained in step (b) is maintained at a pressure of less than 2 bar until the frozen coffee extract is formed in step (c).

This disclosure relates to a method for the manufacture of a foaming coffee powder and, in particular, to a freeze-dried coffee powder. In particular, the disclosure provides a method for the manufacture of a freeze-dried coffee powder that includes high-shear mixing of coffee extract to entrap gas bubbles which, through controlled cooling, persist in the structure of the final product and can therefore form a foam on reconstitution in water.

Instant or soluble coffee powders are well known for expedient production of coffee beverages in the home. In essence, instant coffee is the dried water-extract of roasted, ground coffee. The beans used to make instant coffee are blended, roasted and ground as they are in the making of regular coffee. In order to make instant coffee, the roasted, ground coffee is then charged into columns called percolators through which hot water is pumped, resulting in a concentrated coffee extract. The extract is then concentrated and dried to produce the final coffee composition which is sold to the consumer.

However, it is generally considered that soluble coffee powders fall short of producing the rich coffee products which are produced in cafes and coffee shops from roast and ground coffee beans. Such café-made coffee products have a rich full-bodied flavour and a small foam crema on the surface from the vigorous extraction of the coffee beans. The crema layer is desirable for the consumer as they perceive the beverage to be of improved quality compared to soluble coffee beverages.

Soluble coffee powders can generally be divided into spray-dried and freeze-dried powders, depending on how they have been produced, although other drying methods are also known and used within the field. Both drying techniques (spray-drying and freeze-drying) are well known in the art. Some spray-dried coffee powders may be perceived to be of inferior quality to freeze-dried powders because the high temperature processing leads to a loss of coffee volatiles. In contrast, freeze-drying relies on low temperatures and sublimation, so it is possible to retain more of the volatile coffee aroma profile. However, conventional commercial soluble coffee powders produced with either drying technique do not generally produce a satisfying crema, and it has been an ongoing task to improve the crema formation of the coffee powders upon reconstitution with water.

So far, there have been a number of developments in recent years to tackle the problem of providing a crema on a soluble coffee. This development has focused on trapping gas, typically pressurised gas, in pores within the powder so that it is released when the powder is dissolved.

A number of techniques are known for trapping gas to form a crema, but these typically focus on spray-drying since the method lends itself to the formation of closed pores. EP839457, for example, describes a process for the production of self-foaming spray-dried porous coffee powder. Upon dissolution, the powder is said to form a distinct crema layer.

In contrast, due to the sublimation drying of freeze-drying, the particles have open pores. These are caused by the loss of moisture leaving the particles by sublimation.

In order to provide a powder that resembles a more desirable freeze-dried coffee, but which provides a foam, there have been a number of attempts to make a spray-dried powder look like freeze-dried powder. WO2010112359 describes a process whereby a porous base powder is sintered to form a porous slab. This slab is then texturised to form a granulated product. Upon dissolution, the porous base powder causes the generation of a foam layer. This product is a freeze-dried look-a-like product, but could not be called freeze-dried in the market.

WO2010115697 describes a process whereby a porous base powder is produced through spray-freezing. This powder is then cold-sintered and freeze-dried to form a granulate structure that forms a crema layer upon dissolution.

Other attempts to make a foaming freeze-dried powder have tried to supplement a freeze-dried powder with spray-dried powder to provide the extra foaming effect. For example, WO2015096972 describes a process whereby a partially melted frozen product has porous powder stuck to the surface, the product is then re-frozen and freeze-dried. The porous powder provides a foam layer on dissolution. This process would be quite expensive and the foam layer is not comparable to a spray-dried product.

EP2100514 describes a process whereby a porous coffee powder is chilled and then blended with a partially frozen coffee extract. The mixture is then frozen before the porous powder dissolves. The frozen mixture is then freeze-dried. Upon dissolution the product forms a crema layer.

US2013230628 and US2010215818 relate to methods for the production of instant beverage granules which, upon reconstitution with water, form a foamy upper surface.

EP1627568 relates to a process for preparing an instant beverage is provided which includes heating a dried soluble coffee under sufficient pressure thereby forcing gas into internal voids of the dried coffee.

All of the above disclosures rely on a porous powder to deliver the crema layer. Many cite a so called ‘foaming porosity’ which is the percentage of the particle volume that is comprised primarily of closed pores or voids which, in some cases, includes voids with an opening of less than 2 μm. Moreover, the above processes add significant complexity and cost to the freeze-dried coffee process.

U.S. Pat. No. 3,309,779 relates to a method of dehydrating solids-bearing liquids.

GB1102587 and GB1367616 relate to coffee extract powders produced by foaming an aqueous coffee extract with an inert gas before freeze-drying. GB1288758 relates to a similar method with fines recycling. GB1199564 relates to an alternative freeze-drying method.

EP3448166 relates to a method for the manufacture of a freeze-dried coffee powder that includes adding gas to a pressurised coffee extract in an amount of from 1 NL/kg to 5 NL/kg of coffee extract, to provide a gas-containing coffee extract well above atmospheric pressure; and depressurising the gas-containing coffee extract to form a foamed coffee extract. These pressurisation and de-pressurisation steps were found to provide a more stable foam with a proliferation of small bubbles. However, the equipment required for such high pressure gas injection is expensive and complex. Therefore, a more economical and simpler process for obtaining freeze-dried coffee which forms good crema upon reconstitution with water is desired.

EP0839457 involves the use of a pressurised extract homogenised in a silverson mixer before spray drying. This mixer is operated under a relatively low pressure, but the foamed extract remains under this pressure until it is spray-dried at higher pressure. That is, the elevated pressure is not released before the drying step.

Accordingly, it is desirable to provide a method for manufacturing a freeze-dried or spray-dried coffee with a realistic crema which tackles at least some of the problems associated with the prior art or, at least, to provide a commercially viable alternative thereto.

In a first aspect there is provided a method for the manufacture of a freeze-dried coffee powder, the method comprising:
(a) providing a coffee extract having from 40 wt % to 55 wt % solids;
(b) high-shear mixing the coffee extract in a rotor/stator aerator with added gas to form a foamed coffee extract, the gas being added in an amount of from 1 NL/kg to 5 NL/kg of coffee extract, wherein the rotor/stator aerator is maintained at a pressure of less than 2 bar and is configured to subject the coffee extract to a shear of from 7,500 to 20,000 s⁻¹ in a single pass having a residency time of at least 1 second,
(c) cooling the foamed coffee extract to below-40° C. without shear, or with low shear, to form a frozen coffee extract,
(d) grinding the frozen coffee extract to a powder; and
(e) drying the powder,
wherein the step (c) of cooling the foamed coffee extract to below-40° C. comprises:
   (i) cooling the foamed coffee extract to a first temperature;
   (ii) cooling the foamed coffee extract from the first temperature to a second temperature lower than the first temperature; and
   (iii) cooling the foamed coffee extract from the second temperature to below −40° C.,
   wherein the first temperature is 1° C. above a freezing point of the foamed coffee extract and wherein the second temperature is 3° C. below the freezing point,
      wherein step (ii) has a duration of from 30 minutes to 5 hours, preferably 1 to 4 hours, and
      wherein the foamed coffee extract obtained in step (b) is maintained at a pressure of less than 2 bar until the frozen coffee extract is formed in step (c).

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The inventors investigated high shear mixing of the coffee extract in accordance with EP0839457 and adapting this spray-drying process to a freeze-drying application, but found that the bubble structure was not maintained in the final product when freeze-drying. It was speculated that this was due to the drop in pressure between the bubble introduction and the freeze-drying process. It seemed that the absence of a pressure drop in EP0839457, a function of the spray-drying approach, meant that the bubbles formed in the silverson mixer are maintained until the spraying step. It was therefore concluded that the method of EP0839457 could not be readily adapted. In any event, the equipment requirements were complex, requiring separate addition of gas before mixing.

The inventors have found that a process where the gas is added during a high shear mixing step, avoiding a pressure drop, allows the formation and retention of fine gas bubbles. This gives rise to an improved foaming freeze-dried product, without requiring complex equipment provision.

The method requires the provision of a coffee extract having from 40 wt % to 55 wt % solids. Preferably the coffee extract has from 45 to 53% solids and most preferably from 48 to 51 wt % solids. By solids it is meant the amount of material that remains if the extract is fully dehydrated as a percentage by weight of the original extract. Thus, a 50 wt % solids extract is 50 wt % water. Preferably the solids are dissolved coffee solids. Optionally the solids may also contain roast and ground coffee particles and/or cocoa powder in an amount of up to 20 wt % of the extract, more preferably less than 15 wt % and most preferably less than 10 wt %. However, preferably the solids consist of dissolved coffee solids.

When the level of solids is low, the freeze-drying process is energy intensive due to the amount of water vapour that needs to be removed. When the level of solids is high, there may be insufficient water in the extract to form the necessary ice-crystal void structure required to form the foaming freeze-dried coffee powder.

The coffee extract used as starting material in the process may be prepared by any desired extraction technique. For example, the aqueous extract may be prepared by counter-current percolator extraction of coffee. Such extracts may need to be concentrated in order to achieve the desired level of soluble coffee solids. For example, an extract containing 10 to 20% by weight of soluble coffee solids, is then concentrated, for example by evaporation or freezing, until a concentration of 40 to 55% solid matter is reached. When the concentration is effected by evaporation, it may be preferable first to strip the volatile aromatics from the dilute extract. The aromatics thus recovered may optionally be combined with all or a part of the aromatics stripped from the ground coffee before extraction and may then be added to the concentrated extract before drying or be plated onto the powdered product.

In the high-shear mixing step, a high shear mixer (such as a Silverson or Megatron (Kinematica)) is used to mix the coffee extract to provide a foamed coffee extract. A high shear mixer typically uses a rotor, rotating at high speeds, to direct material outwards towards a stationary stator and thus shear the material. The high-shear mixer is a rotor-stator aerator, which means that as well as providing the high shear, there is also provided means for introducing air during the mixing. Such equipment is known in the field of liquid processing. Preferably, the high-shear rotor-stator aerator is a Megatron aerator. Preferably the rotor stator aerator operates on the basis of toothed rotor and stator components, rather than a screen, since this facilitates the provision of additional shear to the extract for a given energy input.

The high-shear rotor-stator aerator used must be configured to subject the coffee extract to a shear of from 7,500 to 20,000 s⁻¹ in a single pass. This shear rate was unexpectedly found to produce a freeze-dried coffee powder that forms an improved crema upon reconstitution. Although the high shear mixing of the coffee extract may be performed in a single pass, or two or more passes, it is preferred that only a single pass is employed, since this is sufficient to achieve the requisite bubble size. Each pass has a residency time of at least 1 second.

Preferably the gas which is added in the high-shear rotor-stator aerator is selected from nitrogen, air, argon, nitrous oxide and carbon dioxide or a mixture of two or more thereof. The inert gases of nitrogen and carbon dioxide are preferred to avoid degradation of the coffee flavours during storage of the final powder. Nitrogen is further preferred due to its tendency to form smaller, more stable gas bubbles.

The gas is added in an amount of from 1 NL/kg to 5 NL/kg of coffee extract, more preferably in an amount of from 3 to 4.5 NL/kg of coffee extract. That amount of gas added can be readily determined with metered addition of the gas to the coffee extract. The amount of gas added determines the gas bubble structure and gas bubble void amount within the final structure. The gas is measured in normalised litres per kilogram, as determined at 1 atmosphere and 20° C., since this allows for an absolute measure of the gas used regardless of the pressure of gas addition.

The coffee extract is maintained at a pressure of less than 2 bar during the high-shear mixing process. The coffee extract in the rotor/stator aerator is preferably maintained at a pressure of from 1 to 1.8 Bar, preferably from 1 to 1.4 Bar. Maintaining such a low pressure (being close to atmospheric pressure) enables the use of simple and less expensive equipment. In addition, the low pressure requires less energy input, and therefore is a greener method of foaming the coffee compared to previous methods employing high pressures. Furthermore, the use of low pressure avoids a pressure drop during processing, after foam creation, which was believed to cause disruption of the bubble structure.

The foamed coffee extract obtained in step (b) is maintained at a pressure of less than 2 bar until the frozen coffee extract is formed in step (c). Maintaining the coffee extract of such a low pressure enables the use of simple equipment, and is environmentally friendly due to the reduced energy demand (compared to processes employing higher pressures). In addition, such a process was shown to be able to form an instant coffee powder that forms good crema upon reconstitution with water.

Each pass has a residency time, i.e. the time that the coffee extract is held in the rotor/stator aerator of at least 1 second, preferably at least 2 seconds, preferably at least 20 seconds. This is typically controlled with the flow rate and aerator device size. The coffee extract may be held in the rotor/stator aerator for on average at least 30 seconds in each pass, preferably, from 1 second to 2 minutes, preferably 20 seconds to 1 minutes. It should be appreciated that on a pilot-scale basis, as in the examples, shorter durations may be more suitable, whereas on a commercial scale longer durations may be required. This is the optimum time for obtaining the desired amount of shearing of the coffee extract.

According to a further step, the foamed coffee extract is cooled to below −40° C. without shear, or with low shear, to form a frozen coffee extract. It will be appreciated that the coffee extract before this step will generally be at a temperature of from 10 to 50° C. for ease of handling, such as spraying, and any elevated temperature above room temperature will typically be the result of preceding processing steps. The foamed extract is desirably passed directly to a cooling vessel or cooling belt in order to minimise any loss of foam. The low shear during cooling is preferably less than 50s⁻¹.

The step of cooling to below −40° C. to form a frozen coffee extract is a conventional step in freeze-drying. As will be appreciated, the cooling may reach a final temperature of −45° C. or below, such as −50° C. or −60° C. However, unlike conventional freeze-drying, it is essential that this step is performed without applying high shear, or with only low shear being applied to the foamed coffee extract. Indeed, preferably the cooling is carried out without applying shear. Alternatively, low shear may be applied to improve heat transfer, such as by slow mixing or such as that experienced by passing the extract through a simple heat exchanger (i.e. without baffles). Indeed, it is essential that the foamed coffee extract is not vigorously mixed, stirred, agitated or shaken during the cooling step, especially during the cooling step wherein the ice crystals are formed. It is thought that agitation leads to the breakdown of large ice crystals, preventing the desirable larger ice crystal growth and also appears to encourage the ice-crystals to penetrate the gas bubbles to result in greater interconnectivity.

Methods of measuring or calculating shear are well known in the art: for example, “CFD analysis of the flow pattern and local shear rate in a scraped surface heat exchanger” Chemical Engineering and Processing, Yataghene et al. 47 (2008) 1550-1561 discusses shear in a SSHE. It is considered that low levels of shear which are permissible are less than 50 s⁻¹, preferably less than 25 s⁻¹, more preferably less than 15 s⁻¹ preferably less than 5 s⁻¹. In contrast, levels of shear in typical processing apparatus, such as SSHE will be at least 200 s⁻¹.

The step of cooling the foamed coffee extract to below −40° C. is typically a continuous process which may be performed in various ways. For example, the foamed coffee extract may be sprayed into trays and moved, such as on a conveyor or manually, between cool rooms or zones held at different temperatures to control the cooling rate. Alternatively, the foamed extract may be held in a cooling vessel where the vessel and contents are cooled at a controlled cooling rate. Alternatively, the foamed extract may be passed through a heat exchanger such that the cooling rates can be controlled.

Preferably one or more of the cooling steps (i), (ii) and (iii) are conducted as a continuous process using a conveyor. Preferably one or more of the cooling steps (i), (ii) and (iii) are conducted in a holding vessel or within a pumped cooling system. For example, the steps (i) and (iii) may be conducted with a conveyor, while the slow cooling in step (ii) may rely on a cooling vessel, such as a cooling drum, for best cooling control. Preferably all of the cooling steps (i), (ii) and (iii) are conducted as a continuous process using a belt.

Where the cooling steps are carried out in a cooling vessel, a preferred cooling vessel is a gently agitated vessel with a cooling jacket, the cooling jacket containing fluid between −10 and −16° C. The agitator speed, in order to minimise shear is less than about 15 rpm, preferably less than 12 rpm. The residence time in the cooling vessel should at least comprise of the required cooling time as defined by step (ii).

The step of cooling the foamed coffee extract to below −40° C. is carried out such that there is a slow controlled cooling of the foamed coffee extract as it is cooled at least in the region of the freezing point of the coffee extract. This ensures controlled crystal growth. In general, the rate of cooling down to the freezing point and once the extract is frozen is not particularly important, except that fast cooling is more useful for industrial process volumes.

The term “freezing point” as used herein is intended to be synonymous with the melting point of the equivalent frozen coffee extract. As will be appreciated, the precise temperature at which the entirety of an extract freezes may not always equate exactly with the melting temperature, depending on the rate of cooling. However, the melting point of a specific extract can be measured more readily. Moreover, the aim of the method described herein is that the extract freezes very close it the freezing/melting point temperature.

Accordingly, the step of cooling the foamed coffee extract may be considered as three separate steps. These include a first step in which the extract is cooled to a first temperature which is 1° C. above a freezing point of the foamed coffee extract; a second controlled cooling step which cools the foamed coffee extract from the first temperature to a second temperature, lower than the first temperature, which is 3° C. below the freezing point; and a third step of then cooling the foamed coffee extract from the second temperature to below −40° C. The controlled second cooling step has a duration of from 30 minutes to 5 hours, preferably 1 hour to 4 hours, preferably 2 to 3 hours. If the cooling is too fast, then the ice crystals are of insufficient size. If the cooling is very slow, then the ice-crystals can grow so large that the structural integrity of the particles may be compromised leading to faster dissolution and a loss of observed crema. 1 to 3 hours is preferably chosen as it leads to preferable product quality at commercially feasible freezing times. It should be noted that when considering a continuous freezing process, such as a cooled low shear agitated vessel, the step (ii) duration refers to the residence time of the aerated extract in the vessel at the described temperatures.

The inventors have found that there is a balance to be struck between the temperature of step (ii) and the holding time. Higher temperatures favour shorter holding times. Accordingly, when within 1 to 10° C., preferably 1 to 5° C. of the freezing point, a longer holding time is desired (e.g. 2 to 4 hours). When within 15 to 5° C., preferably 15 to 10° C. of the freezing point, a shorter holding time is desired (e.g. 30 minutes to 1 hour).

Preferably the rate of cooling in the first and third steps of cooling will be at least −5° C. per minute, preferably at least −10° C. per minute. This step could be achieved in a heat exchanger or on a freezing belt, providing no ice crystals are formed in the cooling step (i). As will be appreciated, the cooling in the first and third steps may also be slow controlled cooling at temperatures abutting the second cooling step.

The freezing point of a coffee extract varies depending on the level of soluble coffee solids contained in the extract. The freezing point can be determined by DSC and is well documented in literature documents. When the coffee extract has from 40 to 45 wt % dissolved coffee solids, the freezing point is from −5 to −7° C. When the coffee extract has from 45 to 50 wt % dissolved coffee solids, the freezing point is from −7 to −8° C. When the coffee extract has from 50 to 55 wt % dissolved coffee solids, the freezing point is from −8 to −10° C.

The rate of cooling in the second cooling step will typically be less than −1° C. per minute, preferably less than −0.5° C. per minute. This slow rate of cooling is performed to encourage the growth of a small number of larger crystals. Faster cooling would risk the formation of a lot of smaller crystals. The slow cooling is achieved with a low degree of supercooling which is the driving force for the desirable crystal growth. Supercooling reflects the extent to which the extract reaches a temperature below its freezing point before freezing. Low levels of supercooling are achieved by the use of a coolant which is not much colder than the extract during cooling. Preferably the temperature of the extract does not reach more than 1° C. below the freezing point before freezing is complete. The temperature initially falls below the freezing point, causing a degree of super-cooling to exist within the system, this provides the driving force required for spontaneous nucleation of ice-crystals, as the ice crystals begin to form and grow the temperature of the extract rises due to the enthalpy of fusion.

The slow cooling can preferably be achieved using a coolant during step (ii), such as with a heat exchanger. As is known in the art, the wall temperature experienced by the product stream will not be equal to the coolant temperature and will depend on the wall thickness of the heat exchanger, the thermal conductivity of the material of construction, as well as the flow regime of the coolant. As a guide, the coolant preferably has a temperature of no colder than −16° C., and is preferably less than 7° C. cooler than the freezing point, more preferably less than 5° C. cooler than the freezing point. Obviously the coolant cannot be above the freezing point during step (ii), otherwise crystal growth would not be achieved. The use of a coolant at a temperature so close to the freezing point helps to encourage ice crystal growth without supercooling at the interface between the coolant and the extract (such as at a heat exchanger or crystalliser interface). When using a conveyor belt, the coolant may take the form of a cooled gas flow; in such a case the heat transfer, which is a function of the air temperature and velocity, can be calculated to avoid supercooling.

Once the foamed coffee extract is cooled to below −40° C. to form a frozen coffee extract, the frozen coffee extract is ground and dried using conventional methods to form a freeze-dried coffee powder.

For example, once frozen the extract may be obtained as a continuous rigid sheet which may then be broken up into fragments suitable for grinding. These fragments may, for example, be ground to a particle size which is preferably within the range 0.5 to 3.5 mm. Grinding techniques are well known in the art.

The ground frozen powder is dried by sublimation. For example, this may be in conventional cabinets, on trays which are loaded to a layer thickness of, for example, 25 mm. The sublimation of the ice crystals is typically effected under a high vacuum, of <1 mbar, and generally lasts up to 7 hours. Thereafter, the product may be packed as desired.

When starting from the prior art EP0839457, the inventors contemplated an alternative design of high shear mixer, a so-called rotor/stator aerator, which provides high shear mixing with simultaneous addition of a gas. Using this approach they found that a foamed extract could be formed even without using elevated pressures. The inventors found that operating at substantially ambient pressure avoided a pressure drop and minimised bubble disruption before the freeze-drying step.

However, the inventors found that this approach never achieved quite the same gas-bubble size purported in EP0839457 to be optimum. Increasing the pressure, which is suggested in EP0839457 to give smaller, better bubbles, lead to a higher pressure drop and increased bubble disruption.

In any event, the inventors found that under routine conditions, the rotor/stator aerator gave a uniform small bubble size less than 40 microns, preferably less than 20 microns and generally in the region of 8-15 microns, preferably 11-15 microns. Increasing the shear conditions did not significantly decrease the bubble sizes observed, but increased the energy consumption. The measurement is performed on the foamed extract immediately leaving the rotor stator aerator, and is under the pressure conditions of the foamed extract leaving the device. Thus, the method of the first aspect of the invention was unexpectedly and advantageously found to provide a freeze-dried coffee powder under ambient pressure that could be reconstituted with water to produce a coffee beverage with good crema. The ability of the method to operate under low pressure advantageously allowed use of simple and less expensive equipment, as well as being less energy consuming and therefore greener.

Previous understanding states that crema quality depends on sufficiently small bubble sizes (˜20 μm) and a slow freezing profile. However, the inventors surprisingly discovered that crema is dependent on more than just freezing rate and bubble size. Rather, the chemical composition at the bubble surface was found to impact the ability of bubbles to withstand the stresses of freeze drying.

Preferably the step (i) of cooling the foamed coffee extract to a first temperature, comprises a step of holding the foamed coffee extract at a temperature more than 1° C. above, but no more than 10° C. above, a freezing point of the foamed coffee for a duration of from 30 minutes to 4 hours, optionally with low shear agitation. This step advantageously results in maturation of the bubbles in the foam. Although the bubble size does undergo a slight increase in size, it resulted in more stable bubbles, and a better crema was observed upon reconstitution of the instant coffee powder with water. Without wishing to be bound by theory, it is believed that active components are given time during this maturation step to migrate to the surface of the bubbles and/or to reconfigure at the bubble surface to have a stabilising effect. It is speculated that the active components are surfactant components of coffee, such as higher molecular weight coffee proteins and melanoidins.

When using the above described bubble maturation step, the method may further comprise, after step (i) but before step (ii), or after step (ii) and before step (iii), subjecting the extract to one or more further passes through the high shear mixer with equivalent shear. This can reduce the bubble sizes again, does not compromise the improved bubble stability achieved in the maturation step, and allows the maturation step to be performed more quickly.

In a further aspect, there is provided the use of a rotor/stator aerator to foam a coffee extract before freeze-drying to increase the amount of crema formed on reconstitution of the freeze-dried coffee product. This aspect may be combined with any and all features described herein with the other aspects.

The optional step of holding the foamed coffee extract at a temperature more than 1° C. above, but no more than 15° C. above (preferably no more than 10° C.), a freezing point of the foamed coffee for a duration of from 30 minutes to 4 hours, optionally with low shear agitation was found to have a broader application in its own right. That is, it was found that this approach improved the crema bubbles formed when reconstituting a powder obtained by using spray-drying or broader freeze-drying processes.

Thus, in a further aspect of the invention there is provided a method for the manufacture of a foaming coffee powder, the method comprising:
providing an aqueous coffee extract having from 40 wt % to 60 wt % solids, preferably 40 to 55 wt % solids;
foaming the aqueous coffee extract to produce a foamed coffee extract having an average gas bubble size of less than 40 microns, preferably less than 20 microns;
holding the foamed coffee extract at a temperature more than 1° C. above, but no more than 15° C. above, a freezing point of the foamed coffee for a duration of from 30 minutes to 4 hours, optionally with low shear agitation, and
drying the foamed coffee extract to form a foaming coffee powder.

By “foaming coffee powder” it is meant instant coffee powder that can be reconstituted upon addition of water to form a coffee beverage with a layer of crema on its surface. This foaming coffee powder can be freeze-dried or spray-dried coffee powder.

The method of preparing the aqueous coffee extract can be the same as described above for the method of the first aspect of the invention.

The step of foaming the aqueous coffee extract to produce a foamed coffee extract having an average gas bubble size of less than 40 microns, or preferably less than 20 microns, can be done by standard foaming techniques known in the art. In particular, an aerator can be used to inject gas into the aqueous coffee extract in a method in accordance with the first aspect of the invention. Alternatively, the gas may be introduced by gas addition into a pressurised extract as disclosed in EP3448166.

Preferably, the step of foaming the aqueous coffee extract is performed by:
(i) pressurising the aqueous coffee extract and adding gas; or
(ii) high-shear mixing the aqueous coffee extract in a rotor/stator aerator with added gas. These methods have been found to have the most positive effect on the crema formation capabilities of the end coffee powder product.

The foamed coffee extract may be subjected to two or more foaming passes before the holding step, as desired. A second pass was found to increase crema formation of the coffee powder, which is thought to be due to an increased number of bubbles being present in the product.

The step of holding the foamed coffee extract at a temperature more than 1° C. above, but no more than 15° C. above (preferably no more than 10° C. above), a freezing point of the foamed coffee for a duration of from 30 minutes to 4 hours, optionally with low shear agitation, can be done in a crystalliser, or using any other suitable equipment. However, a crystalliser is preferred. The freezing point of a foamed coffee extract is usually in the region of −5 to −10° C., and so the holding temperature is usually in the region of −9 to 5° C.

Preferably, the holding step comprises holding the cooled foamed coffee extract inside a crystalliser vessel at a temperature of from 0 to −5° C. These were found to be the optimum conditions for the maturation step, resulting in bubbles with improved bubble strength, and a coffee powder that forms an improved crema upon reconstitution with water. A crystalliser is essentially a holding vessel with a cooling jacket and means for agitating the contents, such as a paddle mixer.

This holding step can also be referred to as a maturation step. Inclusion of this step into a standard method of forming a foamed coffee powder was unexpectedly and advantageously found to improve crema formation upon reconstitution of the coffee powder with water.

The duration of the holding step is controlled to ensure that the average gas bubble size remains less than 40 microns, preferably less than 20 microns. As explained, an increase in bubble size is observed as a result of the holding step. As long as this increase is kept such that the bubbles remain less than 40 microns, then the positive impact of the maturation step on bubble strength outweighs the increase in bubble size. Most preferably, the bubbles are kept at less than 20 microns, which was found to produce the strongest bubbles and the best crema formation.

The holding step preferably comprises holding the foamed coffee extract inside the crystalliser for at least 30 minutes, preferably at least 60 minutes, more preferably at least 90 minutes, and most preferably at least 120 minutes. Holding the foamed coffee extract for at least 30 minutes provides enough time for migration of surface active components to reach the bubble surface to strengthen the bubbles. A longer time of 60 minutes, or 90 minutes, or 120 minutes, allows more time for such bubble strengthening. However, more than 4 hours results in bubbles becoming too large, and the positive effect of the bubble strength is outweighed. Therefore, the holding time must be less than 4 hours, and is preferably less than 210 minutes.

The holding step may comprise holding the cooled foamed coffee extract inside a crystalliser with an agitation speed of from 5 to 15 rpm, and preferably of from 8 to 12 rpm, and most preferably of approximately 10 rpm.

The step of drying the foamed coffee extract may further comprise: (i) spray-drying the foamed coffee extract; or (ii) freeze-drying the foamed coffee extract. Both of these methods are well-known in the instant coffee field, and both are good techniques for forming an adequate foaming coffee powder.

Preferably the method may further comprise after the holding step and before drying, subjecting the extract to one or more further passes through the high shear mixer as described herein. This can reduce the bubble sizes again, does not compromise the improved bubble stability achieved in the maturation step, and allows the maturation step to be performed more quickly.

The coffee extract used in any of the methods disclosed herein may:
(a) have from 40 to 45 wt % solids and wherein the freezing point is from −5 to −7° C.; or
(b) have from 45 to 50 wt % solids and wherein the freezing point is from −7 to −8° C.; or
(c) have from 50 to 55 wt % solids and wherein the freezing point is from −8 to −10° C.

Preferably, the coffee extract used in any of the methods disclosed herein has from 48 to 51 wt % solids. The foamed coffee extract of any of the methods disclosed herein is preferably at atmospheric pressure before the step of cooling and has a density of from 500 to 800 g/l. These are the most ideal properties of the coffee extract for producing a final coffee powder with the ideal strength, texture, and crema formation.

In a further aspect of the invention, there is provided a freeze-dried coffee powder obtainable by a method disclosed herein.

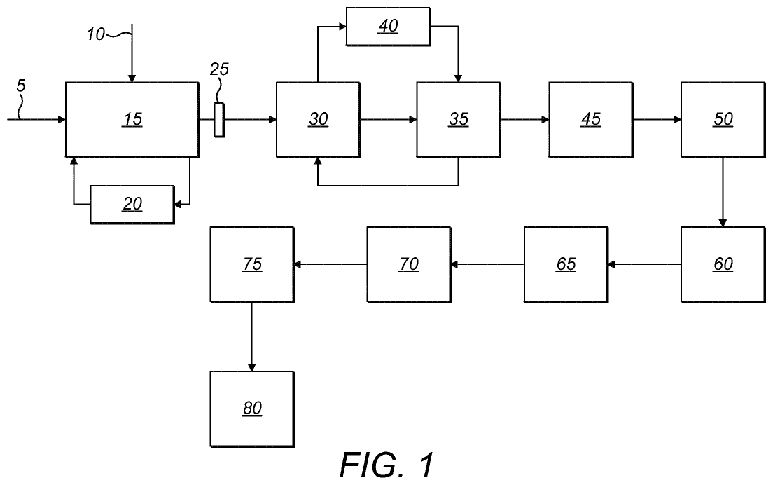

The invention is further illustrated by way of FIGS. 1 to 13, 14a, 14b, and 15 to 17, wherein:

FIG. 1 shows a process by which freeze-dried coffee samples according to the invention are produced.

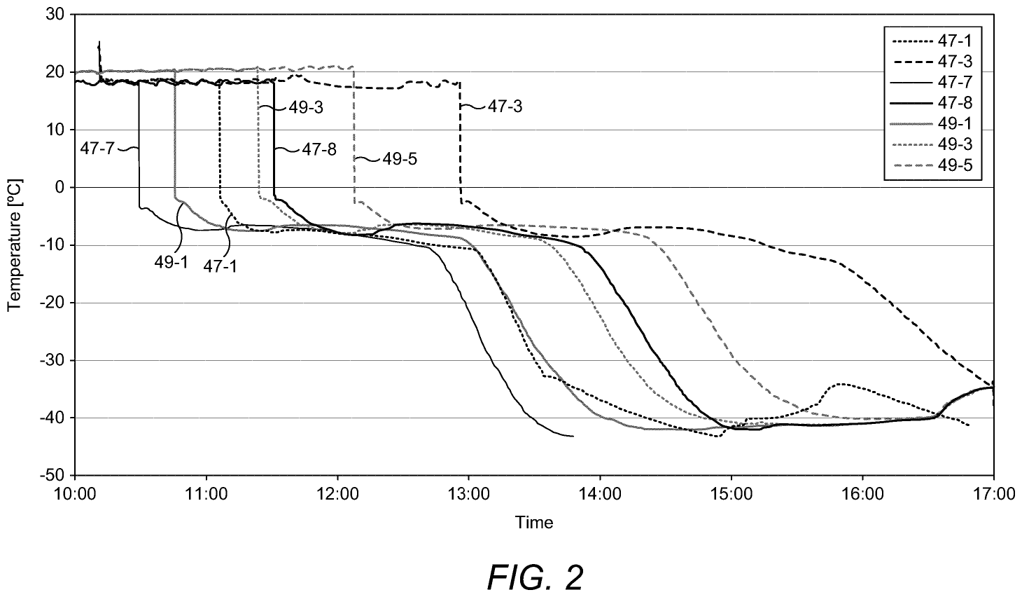

FIG. 2 shows the freezing profile of various sample coffee extracts made according to the invention. The time is shown as being from 10:00 to 17:00 on the x-axis (in 1-hour blocks), and the temperature is shown as being in ° C. from −50 to 30° C. on the y-axis.

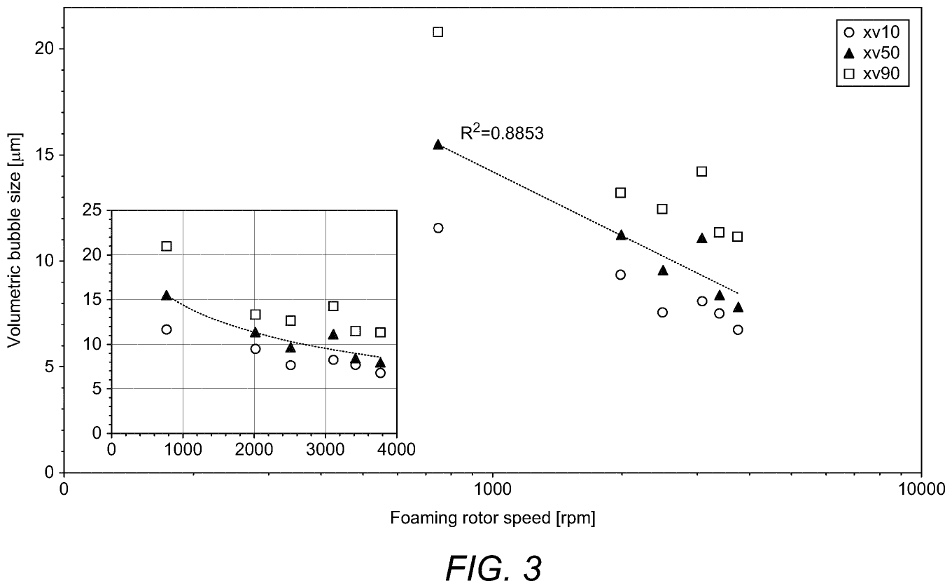

FIG. 3 shows the correlation of volumetric bubble size with increasing rotor speed for a given flow rate. Foaming rotor speed is shown in rpm (from 100 to 10,000) on the x-axis, and volumetric bubble size is shown in μm on the y-axis.

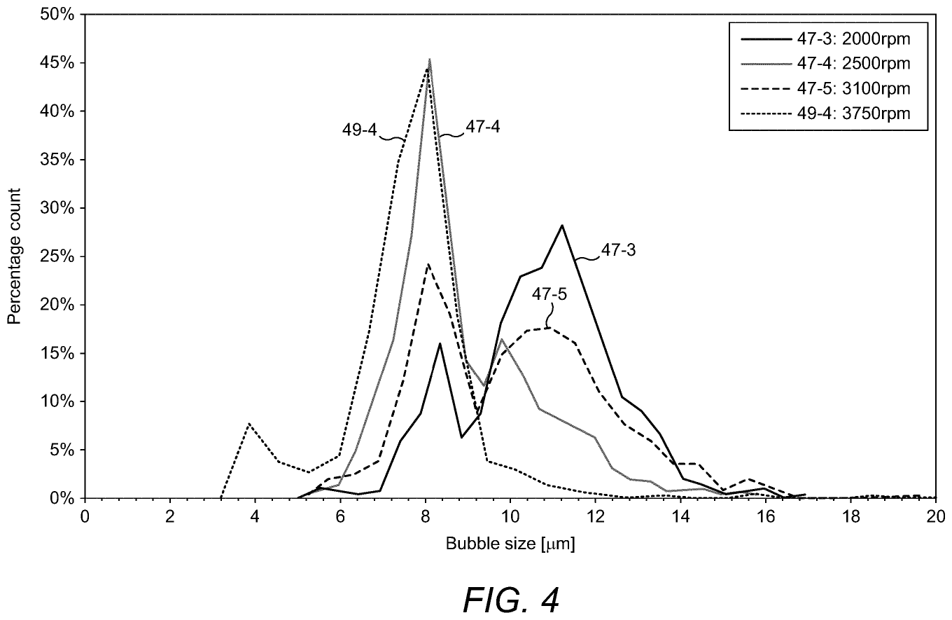

FIG. 4 shows the bubble size distribution of various samples made according to the invention at different rotor speeds. Bubble size is shown in μm on the x-axis, and percentage count is shown on the y-axis.

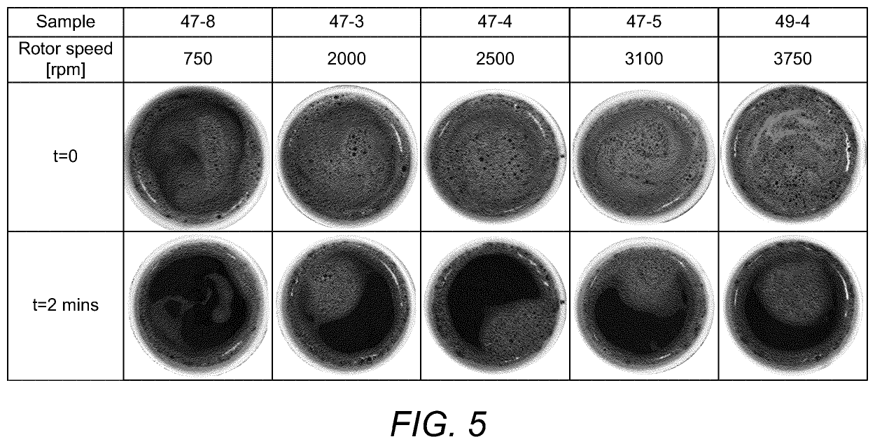

FIG. 5 shows the effect of rotor speed on crema at a given Megatron residence time for various samples made according to the invention.

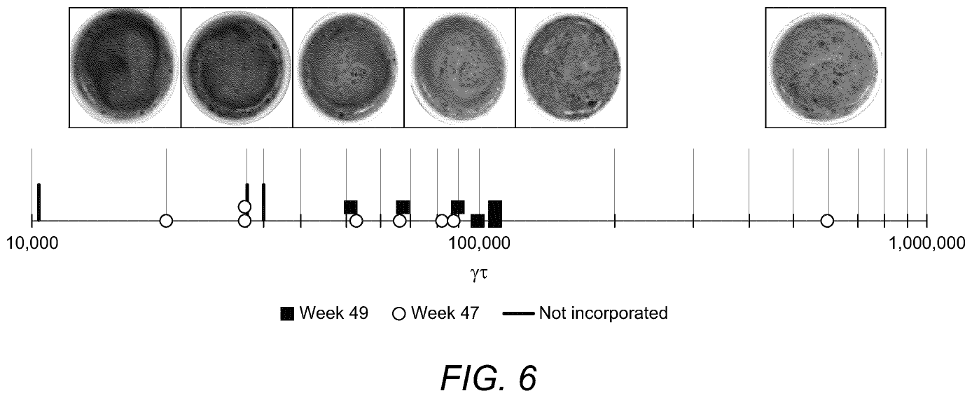

FIG. 6 shows a correlation of with crema quality for various samples made according to the invention. is shown as being from 10,000 to 1,000,000.

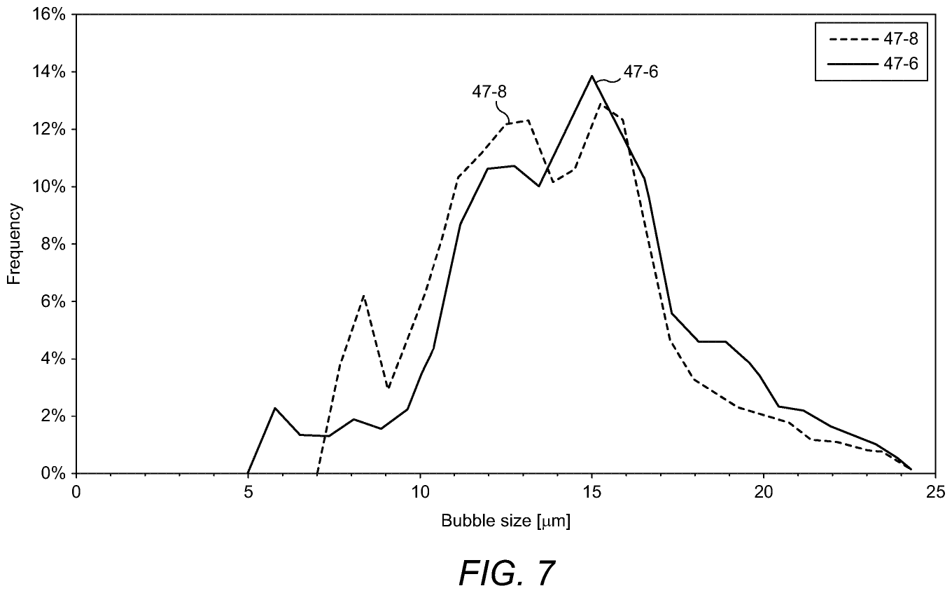

FIG. 7 shows bubble size distribution of two samples made according to the invention. Bubble size is shown in μm on the x-axis, and frequency (i.e. percentage count) is shown in % on the y-axis.

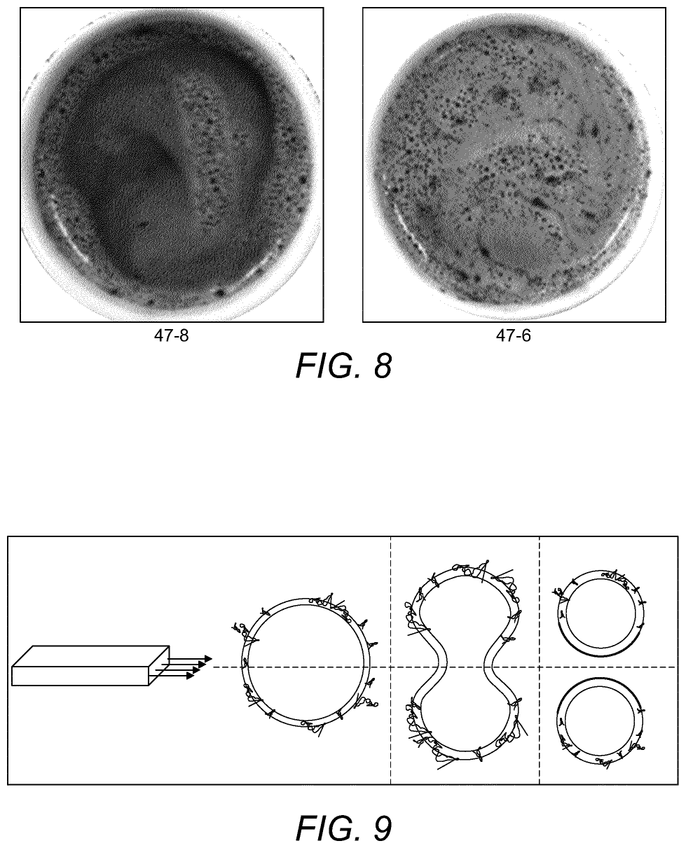

FIG. 8 shows the crema formation of two cups of coffee made upon reconstituion with water of two sample coffee powders made according to the invention.

FIG. 9 shows the mechanism by which bubbles are broken up in a Megatron unit.

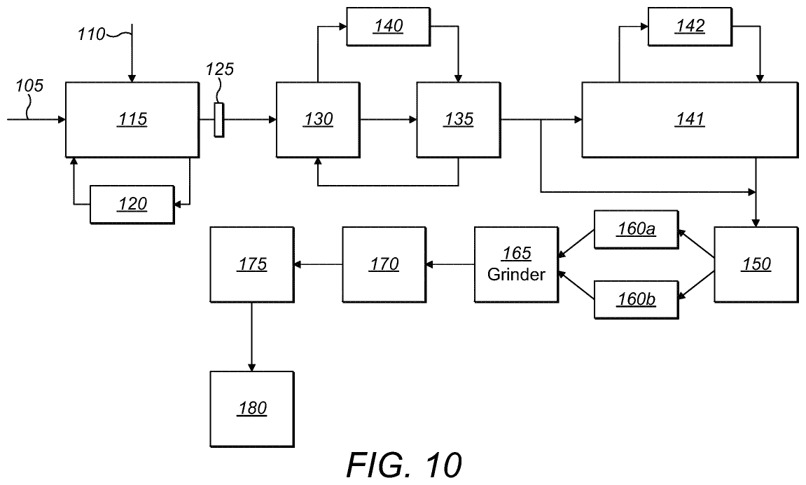

FIG. 10 shows a process by which freeze-dried coffee powder was produced according to the invention.

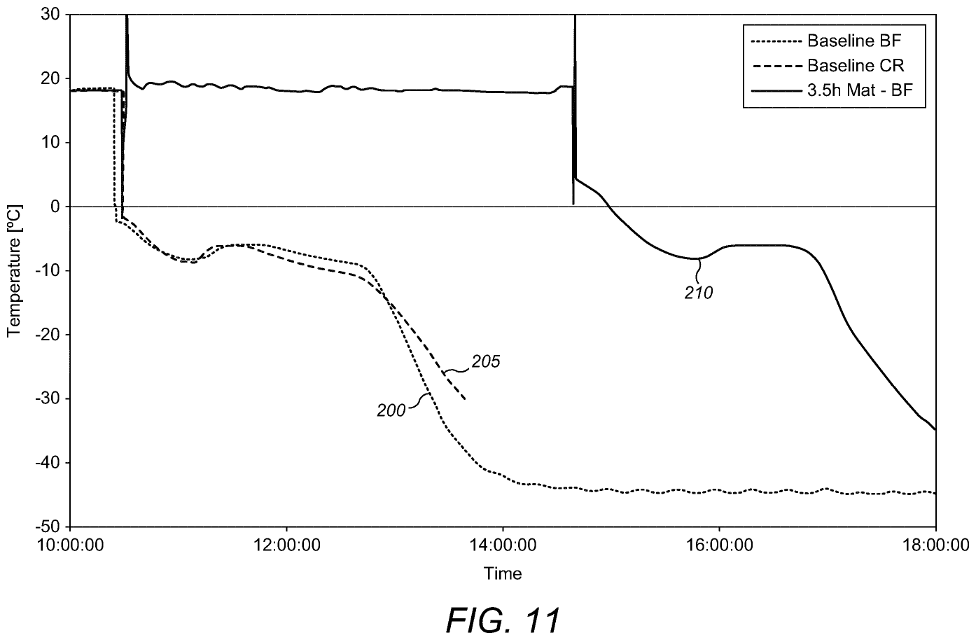

FIG. 11 shows the freezing profiles of comparative and inventive samples made according to the invention. The time is shown as being from 10:00 to 18:00 on the x-axis (in 1-hour blocks), and the temperature is shown as being in ° C. from −50 to 30° C. on the y-axis.

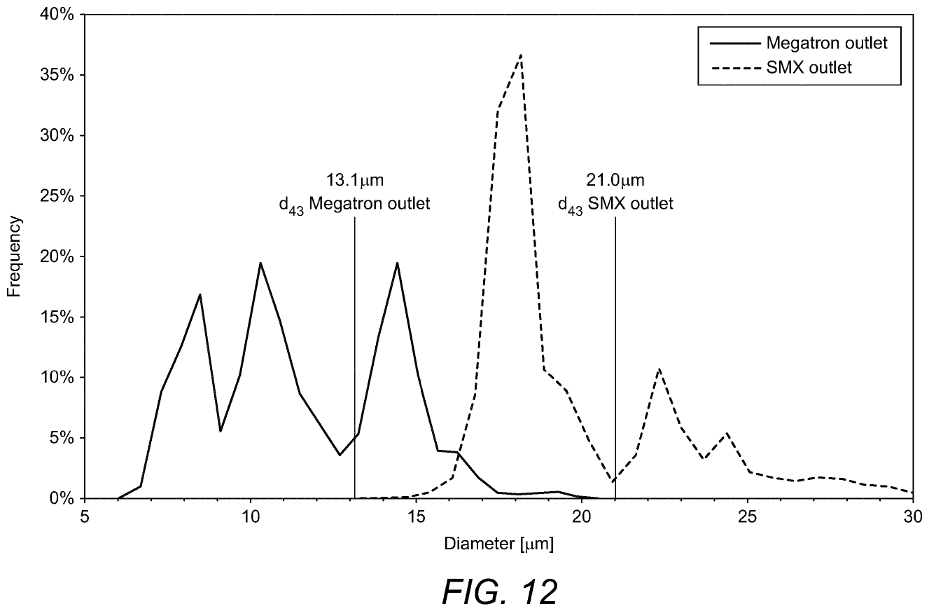

FIG. 12 shows the bubble size distribution of comparative and inventive samples made according to the invention. The diameter (i.e. bubble size) is shown as being in μm on the x-axis, and frequency (i.e. percentage count) is shown on the y-axis.

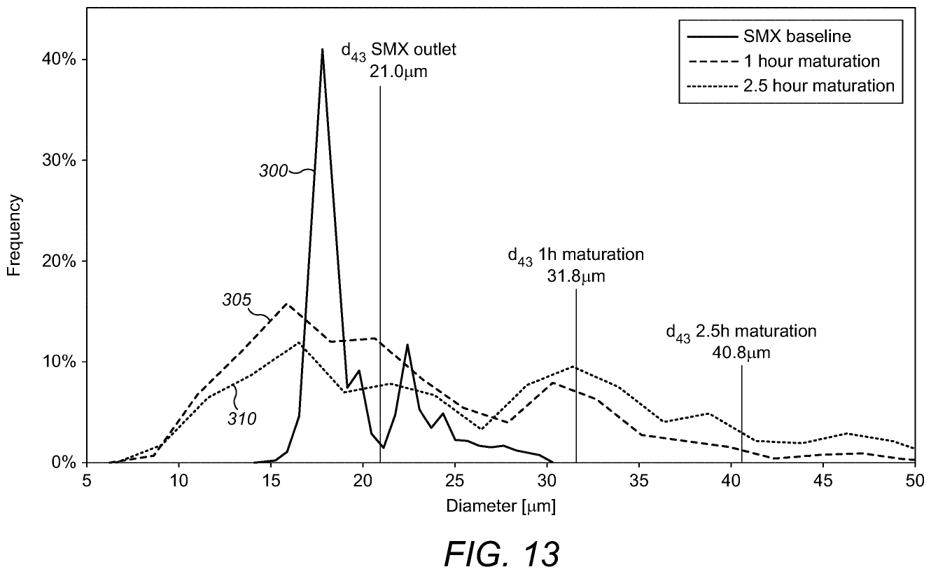

FIG. 13 shows a comparison of bubble size distribution of samples made according to the invention after different maturation periods. The diameter (i.e. bubble size) is shown as being in μm on the x-axis, and frequency (i.e. percentage count) is shown on the y-axis.

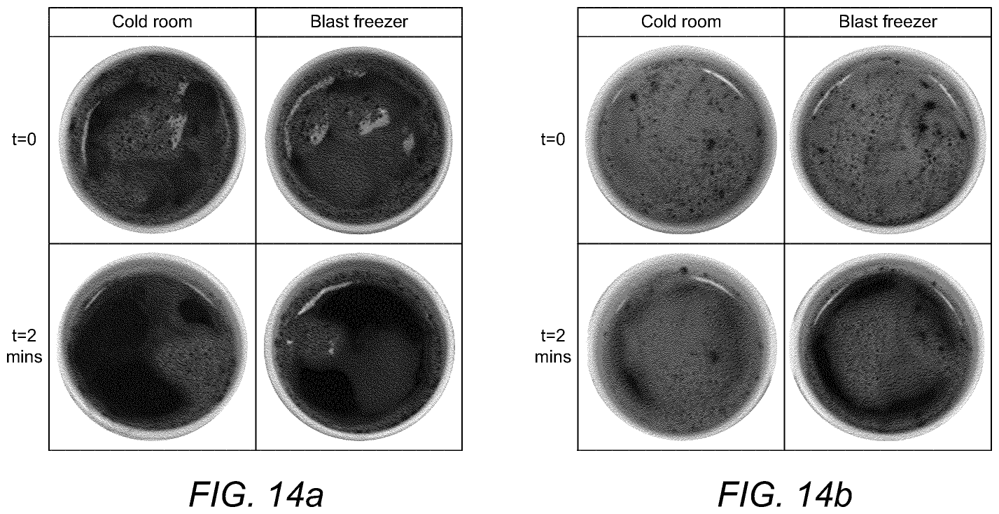

FIG. 14a shows the effect on crema quality of a comparative sample having not undergone a maturation step.

FIG. 14b shows the effect on crema quality of a sample made according to the invention, having undergone 3.5 hours of maturation.

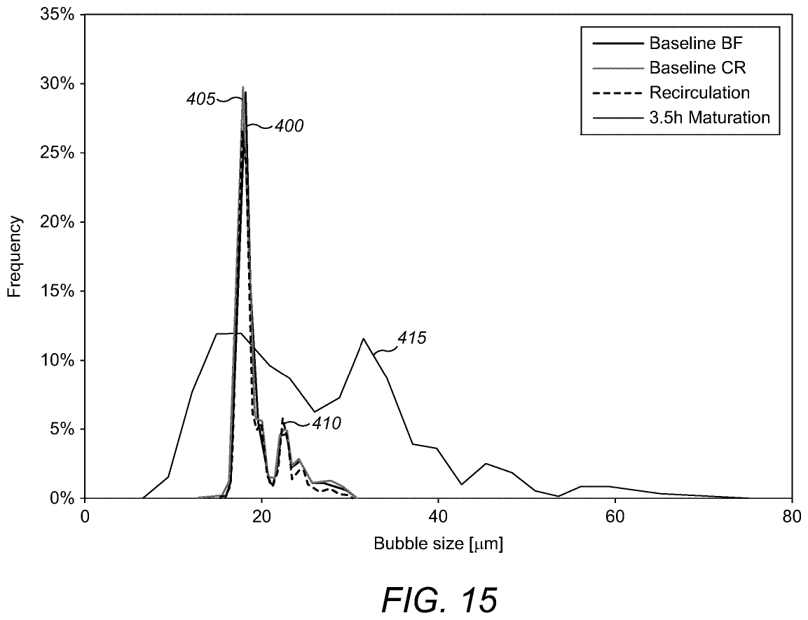

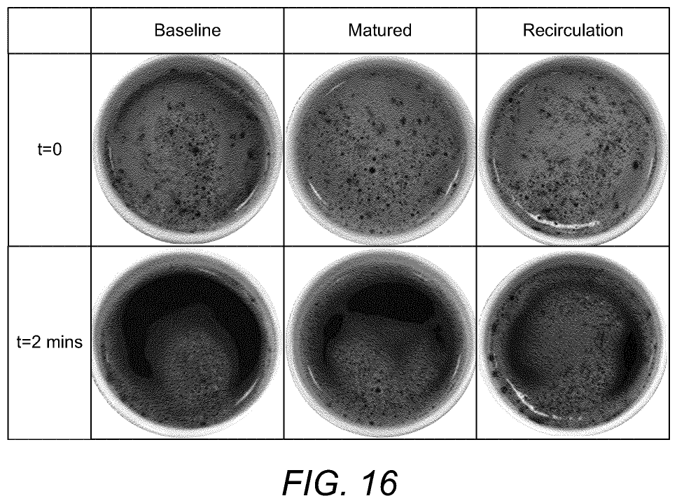

FIG. 15 shows the bubble size distribution of various comparative and inventive samples made according to the invention. The diameter (i.e. bubble size) is shown as being in μm on the x-axis, and frequency (i.e. percentage count) is shown on the y-axis.

FIG. 16 shows the final product crema of various comparative and inventive samples.

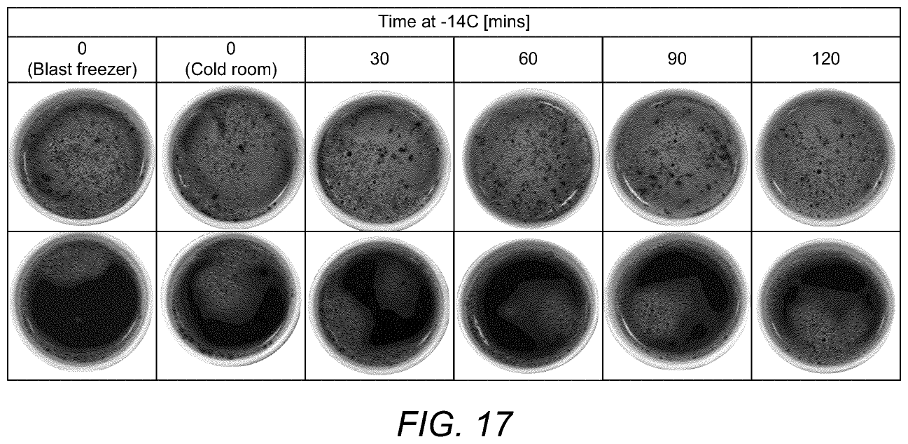

FIG. 17 shows the final product crema of various inventive samples after different freezing profiles.

It is noted that the term “powder” is used throughout to refer to the freeze-dried product. This term is synonymous with the term granules which is also used in common parlance to described such freeze-dried coffee products.

### EXAMPLES

### Example 1

The process by which the freeze-dried coffee samples were produced is shown in FIG. 1.

Coffee extract (5) was obtained with a 50% w/w soluble solids. The coffee extract (5) was fed to the Megatron MT-75 (Kinematica AG, Switzerland) (15) which foamed the coffee with Nitrogen (10) (fed to Megatron). The Megatron operating conditions were changed according to the Design of Experiments (DoE) (given in Table 1). The DoE was intended to test a range of Megatron conditions, with emphasis on rotor speed and residence time. These were said to be the most significant parameters for bubble size, according to literature reviews. Sample codes 47-1 to 47-8, and 49-1 to 49-6 denote the relevant sample tested under the specific conditions shown in Table 1 (47 and 49 simply indicate the week in which the samples were prepared). A SOPAT (Germany) measuring probe (25) was placed at the outlet of the Megatron MT-75.

Coffee and nitrogen flow rates were manually adjusted to give constant product density of 650 kg/m³. A function for coffee mass flowrate in terms of feed pump rotor speed was calculated and found to correlate with a high degree of accuracy. The product temperature was controlled using an attached Megatron glycol chiller (20) (product temperature target of around 20° C.).

Aerated coffee then passed through a plate pack heat exchanger (30) and static mixer (35). Both of which were cooled by a separate glycol chiller unit (40). The target temperature at the static mixer outlet was around −5° C. Trays (45) of cold, foamed extract were collected at the static mixer outlet before beginning the freezing process. The first stage of which involved 2 h in a freezer cabinet (50) set at −14° C. Trays of partially frozen coffee were then transferred to the cold room (60) at −50° C. via a moveable polar blast freezer (set point: −50° C.). After sufficient freezing, the samples were ground in a grinder (65) and sifted in a sifter (70) before drying in Ray 1 pilot plant freeze dryer (GEA NIRO) (75) to provide a final freeze-dried coffee powder (80). The drying profile in Ray 1 was designed to be gentle to prevent melt-back. Set points of the heating plate and product were 50° C. and 45° C. respectively which were reached after around 8 h.

TABLE 1

| | | | Coffee | | | Foaming |
|---|---|---|---|---|---|---|
| Sample | Feed pump [rpm] | | flowrate [kg/h] | Rotor speed [rpm] | | temperature [° C.] |
| 47-1 | 400 | LOW | 34.6 | 750 | LOW | 15-20 |
| 47-2 | 400 | LOW | 34.6 | 750 | LOW | 15-20 |
| 47-3 | 600 | MID | 51.9 | 2000 | MID | 15-20 |
| 47-4 | 600 | MID | 51.9 | 2500 | MID | 15-20 |
| 47-5 | 600 | MID | 51.9 | 3100 | HIGH | 15-20 |
| 47-6 | 100 | V LOW | 8.6 | 3750 | HIGH | 25-30 |
| 47-7 | 400 | LOW | 34.6 | 2200 | MID | 15-20 |
| 47-8 | 600 | MID | 51.9 | 750 | LOW | 15-20 |
| 49-1 | 600 | MID | 51.9 | 3400 | HIGH | 15-20 |
| 49-2 | 1156 | HIGH | 100 | 3750 | V HIGH | 15-20 |
| 49-3 | 800 | H MID | 69.2 | 3400 | HIGH | 15-20 |
| 49-4 | 600 | MID | 51.9 | 3750 | V HIGH | 15-20 |
| 49-5 | 500 | L MID | 43.2 | 3400 | HIGH | 15-20 |
| 49-6 | 500 | L MID | 43.2 | 3400 | HIGH | 20-25 |

### Methods

### Bubble Size Distribution (BSD)

For all tested Megatron conditions, BSD data was obtained via the in-line SOPAT probe (SOPAT, Germany). The probe was placed at the Megatron outlet. Triggers of 10 images were taken every minute during the trial. After the trial, the relevant images for each sample were selected for analysis. Images were selected based on tray collection times. A short buffer was included to account for residence time downstream of the Megatron before tray collection; ensuring images accurately represented the associated sample.

### Foamed Extract Density Measurement

Density was controlled for all samples. There were two points in the process where density measurements were taken: the Megatron outlet and the static mixer outlet. Density at the former was aimed at 650 kg/m³ while the latter was slightly more dense (˜670 kg/m³). The increase in static mixer outlet density is due to post-Megatron cooling.

At the Megatron outlet, measurements were obtained by sampling the coffee foam via a pre-installed sampling valve. The static mixer samples were taken directly as its outlet was open at all times. For both sampling points, density was determined simply by measuring the mass of coffee foam within a vessel of known volume. Density was calculated as the ratio of mass to volume.

### Freezing Profile Analysis

The coffee temperature during freezing was continuously measured via the use of thermal probes (Ellab, UK). Thermal probes were distributed amongst trays taken throughout the trial. This allowed operators to check freezing profiles were consistent through the trial. Analysis of the freezing profile results was conducted after each respective trial day and used to check the validity of the observed crema quality.

### Product Packing Density Analysis

Bulk density of the dried instant coffee granules was measured analogously to the foamed extract density measurement. A slightly different set-up was used, although the principle remains the same. Standard bulk density measurement apparatus was used. The mass of dried coffee powder within the cup was measured. Packing (bulk) density was then calculated as the ratio of this mass value to the known cup volume. A specification was created whereby all dried powders should have packing densities of around 240 kg/m³, to ensure consistent and realistic granule porosity.

### Crema Analysis

The crema quality of the dried samples was tested following the standard FD Crema test procedure. 3 g coffee powder of each sample was added to identical porcelain cups. 250 ml of 90° C. water (tap water from Banbury, UK) was used to reconstitute the coffee followed by immediate light stirring. Product images were captured on initial rehydration (after stirring) and after 2 min.

### Results

### Packing Density Analysis

The bulk packing densities of samples 47-1 to 47-8 are shown in Table 2. Between these, there was minimal variation. All samples fell between 219.8-250 kg/m³ which was well within specification.

TABLE 2

| Sample | Packing Density [g/l] |
|---|---|
| 47-1 | 229.9 |
| 47-2 | 237.8 |
| 47-3 | 228.1 |
| 47-4 | 227.2 |
| 47-5 | 249.6 |
| 47-6 | 219.8 |
| 47-7 | 232 |
| 47-8 | 226.5 |

### Freezing Profile Analysis

The freezing profile was designed to be conducive to good crema. This was implemented by including a 2 hour period at relatively warm freezing temperatures (around −7° C.). Under these conditions, the coffee phase is thought to be sufficiently mobile to allow the diffusion of water to ice crystals. As such, crystals grow during freezing, resulting in a frozen sample with minimal unfrozen water.

FIG. 2 shows that freezing profiles between trial weeks were very similar. The only slight outlier was sample 47-3 which followed a visibly gentler profile. This was attributed to the sample being slightly too thick in the tray. This decreased the rate of cooling at the centre of the tray: where the thermal probe measured. All freezing profiles were sufficiently similar to not cause significant differences in crema.

### Bubble Size Distribution Analysis

Following trends in literature, volumetric bubble size was found to decrease with increasing rotor speed for a given flow rate. With a coffee flow rate of 52 kg/h, the correlation was fitted to a logarithmic trend with good accuracy. This is shown in FIG. 3.

The bubble size reduction with increasing rotor speeds diminishes at values greater than 2000 rpm. This is more apparent when considering the BSDs, as shown in FIG. 4. At high rotor speeds, bubble coalescence counteracts the bubble size reduction from increased rotor-induced break-up. This equilibrium bubble size appears to be around 8 μm.

Interestingly, FIG. 4 also shows a less frequent repeated peak at around 12 μm. This is expected to be the result of coalescing bubbles and was shown to be most prominent for the lowest tested rotor speed. This trend can be explained by considering that, at faster rotor speeds (despite inducing more coalescence), these 12 μm bubbles are more rapidly broken by the rotor. Therefore, the breakage rate is equal to the rate of coalescence and a monomodal distribution is achieved.

Mean bubble size was not found to significantly change with flow rate in the tested range. This further suggests rotor speed is the key parameter influencing bubble size. The complete data set of volumetric mean bubble size for all collected samples is given in Table 3. It should be noted that despite some variance, all samples had bubble sizes which are considered small in the context of FD crema (<20 μm).

TABLE 3

| | Coffee flowrate | Rotor speed | De Brouckere mean |
|---|---|---|---|
| Sample | [kg/h] | [rpm] | bubble size [μm] |
| 47-1 | 34.6 | 750 | 23.14 |
| 47-2 | 34.6 | 750 | 23.58 |
| 47-3 | 51.9 | 2000 | 11.28 |
| 47-4 | 51.9 | 2500 | 9.76 |
| 47-5 | 51.9 | 3100 | 11.26 |
| 47-6 | 8.6 | 3750 | 16.45 |
| 47-7 | 34.6 | 2200 | 9.58 |
| 47-8 | 51.9 | 750 | 15.80 |
| 49-1 | 51.9 | 3400 | 10.80 |
| 49-2 | 100 | 3750 | 11.01 |
| 49-3 | 69.2 | 3400 | 8.23 |
| 49-4 | 51.9 | 3750 | 8.68 |
| 49-5 | 43.2 | 3400 | 8.65 |
| 49-6 | 43.2 | 3400 | 8.74 |

### Product Crema Analysis

All samples experienced very similar freezing profiles and had small bubble sizes. As such, good crema was expected. However, this was not always the case. A range of crema qualities was observed between the samples. For all samples, crema was found to be better at greater rotor speeds and residence times, with rotor speed the more influential parameter. The effect of rotor speed on crema at a given Megatron residence time is shown in FIG. 5.

A dimensionless number was calculated to include rotor speed and flowrate: which is the product of approximate shear rate, [1/s], and residence time, [s]. These were calculated according to Equations 1 and 2 respectively. Shear rate (given in equation 1), which is a function of rotor speed, rotor diameter and gap spacing (, , and respectively). The equation provides an estimation of shear rate.

$$\dot{γ} = \frac{π dn}{s} \qquad ( 1 )$$

Another common parameter is the residence time, . This is calculated from chamber volume, , and volumetric flowrate, , as shown in Equation 2.

$$τ = \frac{V}{{\dot{V}}_{f}} \qquad ( 2 )$$

As shown in FIG. 6, was seen to be a good indicator of crema qualityUnder extreme conditions of high coffee throughputs, gas was not always incorporated successfully into the foam. This undesirable effect could be caused by mixer geometry or insufficient energy input. The values which saw poor gas incorporation are included in FIG. 6 as red bars. Incorporation was found to be better at high rotor speeds.

As shown in FIGS. 7 and 8, despite having near identical BSDs (FIG. 7) and post-Megatron handling, the crema performance was significantly different between samples 47-6 and 47-8 (FIG. 8). The only difference in process conditions came from within the Megatron itself: the sample with good crema was foamed under much higher rotor speed, with increased residence time.

Without wishing to be bound by theory, it is considered that the surface chemistry of the bubbles plays an important role in the reason for the improved cream.

It is known there are several types of surface-active molecules within coffee. These can be categorised by their relative molecular weights. Being smaller, low molecular weight (LMW) surfactants diffuse more quickly to the bubble interface so are expected to populate a large proportion of available bubble surfaces. This is supported by studies showing the surface tension of coffee reducing over time: an indication of LMW surfactant adsorption. Contrarily, high molecular weight (HMW) surfactants diffuse more slowly. Adsorption of this surfactant type typically results in increased bubble viscoelasticity and mechanical strength.

In coffee systems, the HMW surfactants are expected to be melanoidins: complex Maillard reaction products formed in the polymerisation of various carbohydrates and proteins during roasting. The mechanical strength associated with HMW surfactant adsorption is desired. It is believed that stronger bubbles will be able to survive the stresses associated with freeze drying. Hence, greater HMW surfactant adsorption gives better product crema.

The link between increased rotor-speed to increased HMW surfactant diffusion and adsorption rates is described below, and focuses on the concept of improved mass transfer.

Mass transfer of surface-active material is especially relevant to the HMW fraction where diffusion is often the rate-limiting step. It is well understood that better mass transfer occurs in turbulent systems. Moreover, turbulence increases with rotor speed. The onset of turbulence seems to occur at around 2200 rpm rotor speed. This correlates well to the minimum rotor speed which led to good crema quality. This suggests a link between turbulence and crema quality.

In sufficiently turbulent conditions, diffusive effects can be considered negligible. As such, the disparity between the diffusive mass transfer rates of HMW and LMW surfactants can be ignored. While this levels the playing-field in terms of mass transfer, it can be considered a relative improvement for the HMW fraction which was previously at a disadvantage. As well as causing greater mass transfer, increased turbulence could increase the rate of bubble break-up.

Another predictable result of increased rotor speed (and, therefore, shear rate) is that bubbles are more frequently ‘chopped’. It is expected that this bubble break-up generates ‘clean’ bubble surfaces: that is, surfaces without adsorbed molecules. The mechanism is depicted in FIG. 9. It has been demonstrated that surfactant adsorption is significantly faster onto clean surfaces.

In parallel to the improved mixing and break-up effects of high rotor speed, another contribution relates to the fluid boundary layer around the bubbles. It is understood that increasing rotor speed causes greater rotational velocities of both the rotor and the coffee. It is well-documented that high velocity at bubble surfaces leads to a thinning of the bubbles' surrounding boundary layer. It stands to reason that a decrease in adsorption distance will increase the rate of surfactant adsorption.

### Example 2

Freeze-dried coffee powder was produced according to the process depicted in FIG. 10. First, coffee extract (105) is obtained via extraction. The coffee extract (105) was a robusta-based spray dried blend and was diluted to 50% w/w soluble solids. The coffee extract (105) is then passed to an aeration unit (115) to undergo foaming. The aeration unit was a Megatron MT-75 (Kinematica AG, Switzerland) which foamed the coffee with Nitrogen (110). The Megatron operating conditions were kept constant through the trial (conditions in Table 4 below). Such conditions had been found to lead to relatively poor crema in previous trials but were selected to highlight any improvements in crema quality due to maturation.

TABLE 4

| | | |
|---|---|---|
| Rotor speed | 2000 | rpm |
| Pump speed | 600 | rpm |
| Coffee flowrate | 52 | kg/h |
| Foaming | 20 | ° C. |
| temperature | | |

Once foamed, extract foam was cooled to around-3° C. by a plate heat exchanger (130) and subsequent static mixer (135). Both were cooled using a glycol chiller (140). As per the standard process without maturation, a set of trays were collected at the static mixer outlet and frozen. These samples are referred to as ‘Baseline’ samples (143).

The foamed coffee extract was then passed to a holding unit (141), otherwise known as a maturation unit. The holding unit (141) used was a crystalliser tank, with a wall temperature maintained between 0 and −5° C. Extract foam was held inside the crystalliser for up to 3 hours under light agitation (agitator speed=˜10 rpm) to prevent settling. The time required to fill the crystalliser (141) was included in maturation time calculations, leading to a maximum tested foam maturation time of 3.5 h. Samples were taken after different maturation periods and freeze-dried under standard procedure.

The matured coffee extract was then subjected to a freezing process (150; 160a; 160b). First, the matured coffee extract was passed to a crystallisation unit (150) for initial cooling. Each sample was exposed to an initial period of 2 h at around −12° C. to grow ice crystals.

The cooled coffee extract was then passed to a freezing unit (160a; 160b) for belt freezing. In this part, samples were cooled to −50° C. by placing them in the cold room (160b). In some cases, extra trays were taken to explore the effect of increasing cooling rate from −12° C. to −50° C. This was done via the use of the blast freezer (160a) which better replicates the freezing belt in the plant. The list of samples collected and their associated freezing methods are given in Table 5.

TABLE 5

| | | Time in PBC | |
|---|---|---|---|
| | Maturation | at −14° C. | Secondary |
| Sample | time [hours] | [mins] | freezing method |
| Baseline-CR | 0 | 120 | Cold room* |
| Baseline-BF | 0 | 120 | Blast freezer** |
| 1 h Mat | 1 | 120 | Cold room |
| 2.5 h Mat | 2.5 | 120 | Cold room |
| 3.5 Mat - BF | 3.5 | 120 | Blast freezer |
| 3.5 Mat - CR | 3.5 | 120 | Cold room |

*Refrigerated room kept at~−50 C. Selected samples were simply placed inside this cold room to freeze.
**Controlled fans which increase air flow around samples within the cold room. These increase the cooling rate towards −50 C.

After sufficient freezing, samples were ground in a grinder (165), then sifted in a sifter (170) before being dried in a Ray 1 (175) to produce a final dried coffee powder (180). The set points of the heating plate and product were 50° C. and 45° C. respectively.

### Methods

Bubble Size Distribution Analysis For all tested Megatron conditions, BSD data was obtained via the in-line SOPAT probe (SOPAT, Germany). BSD was measured at the static mixer (135) outlet and at the crystalliser (141) outlet. The former was to assess the state of bubbles produced before freezing in the standard process (baseline samples). The latter was to measure bubble growth over the maturation period. An appropriate number of triggers were selected for each reading to ensure reliable results.

### Foamed Extract Density Measurement

Density was controlled for all samples by adjusting ratio of gas to coffee flowrates. Density was measured at the static mixer outlet where a value of around 670 kg/m³ was targeted (slightly greater than the standard 650 kg/m³ owing to reduced temperatures).

### Freezing Profile Analysis

The coffee temperature during freezing was continuously measured via the use of thermal probes (Ellab, UK). Thermal probes were distributed amongst trays taken throughout the trial. Trays were selected which underwent different freezing profiles to verify that a difference was experienced. Analysis of the freezing profiles was conducted after the trial and used to check the validity of results.

### Product Packing Density Analysis

Bulk density of the dried instant coffee granules was measured analogously to the foamed extract density measurement. Standard bulk density measurement apparatus was used. The mass of dried coffee powder within the cup was measured. Packing (bulk) density was then calculated as the ratio of this mass value to the known cup volume.

This was employed to check validity of results. A specification was created whereby all dried powders should have packing densities of around 240 g/l. This was to ensure consistent and realistic granule porosity.

### Crema Analysis

The crema quality of the dried samples was tested following a new standard FD Crema test procedure. The new variation involved removing the stirring step to further reduce variability. 3 g coffee powder of each sample was added to identical porcelain cups. 90° C. water (tap water from Banbury) was used to reconstitute the coffee. Product images were captured on initial rehydration and after 2 min.

### Results

### Packing Density Analysis

Packing (bulk) density was measured to ensure products met packing specification. All samples fell well within the accepted specification which adds validity to results. Measured packing densities are given in Table 6.

TABLE 6

| Sample | Packing Density [g/l] |
|---|---|
| Baseline-CR | 223.9 |
| Baseline-BF | 223.3 |
| 1 h Mat | 216.7 |
| 2.5 h Mat | 220.0 |
| 3.5 Mat - BF | 223.9 |
| 3.5 Mat - CR | 225.0 |

### Freezing Profile Analysis

FIG. 11 shows the measured freezing profiles of several samples. Samples were selected for analysis that allowed comparison of secondary freezing method (cold room versus blast freezer) and freezing variation over time respectively.

Comparing the Baseline-CR and Baseline-BF samples, FIG. 11 shows the blast freezer cools at a faster rate than the cold room. This verifies the blast freezer was working as intended. FIG. 11 shows the Baseline-BF (200) and 3.5 h Mat-BF (210) samples had comparable freezing profiles.

### Bubble Size Distribution Analysis

BSD was compared between Megatron outlet and static mixer outlet, as shown in FIG. 12. It was clearly seen that bubble size increases through the plate heat exchanger and static mixer cooling stages. This was expected since pressure drops between these points of measurement. Volumetric mean bubble size (d_{4,3}) was used in conjunction with the Ideal Gas Law to predict the mean expansion of bubbles caused by such condition changes. The expected d_{4,3} at the static mixer outlet was calculated as 17.7 μm; notably less than the 21.0 μm which was observed. This discrepancy likely indicates irreversible bubble destabilisation such as ripening and coalescence.

A comparison of BSD after different maturation periods is given in FIG. 13. This shows significant bubble growth between the static mixer outlet (300) (standard process with no maturation) and after 1 hour maturation. This growth continued with further maturation. Data was obtained for 1 hour of maturation (305), and 2.5 hours of maturation (310).

The distributions shown in FIG. 13 suggest ripening is a significant bubble growth mechanism during the maturation period. This is evidenced by the characteristic decrease in bubble size at the smaller end of the distribution, coupled with an average increase in bubble size. This fits the ripening mechanism wherein small bubbles become smaller as gas diffuses towards larger bubbles which correspondingly grow.

Low maturation temperatures were chosen in this trial (between 0 and −5° C.) in an attempt to limit bubble growth. Had this temperature been higher, it is expected that this bubble growth would have been more severe.

### Product Crema Analysis

FIGS. 14a and 14b show the crema quality of samples produced after different maturation times. FIG. 14a shows the effect on crema quality after no maturation and FIG. 14b shows the effect on crema quality after 3.5 hours of maturation. For each of the shown samples (frozen in the cold room or the blast freezer), freezing and drying profiles were identical. As shown, maturation of any length improved crema quality over the baseline sample. Moreover, the positive trend of increasing crema quality with maturation time was seen across all samples.

These results show that over maturation, bubbles appear to become stronger. This observation is made more significant by the severe bubble growth that occurred during maturation. Such an increase in bubble size would have previously been assumed to lead to a poorer crema quality. Rather, these results suggest that, at least up to ˜50 μm, bubble strength is more influential than bubble size. It is important to consider the BSD as well as mean size. It was demonstrated that a decent proportion of small bubbles remain after maturation (see FIG. 12).

It is expected that there will be a limit to the improvements afforded by maturation. After greater than 3.5 h, bubbles will continue to grow. It is predicted that eventually bubbles will be so large that poor crema is made, regardless of bubble strength. Therefore, a maturation period of up to 4 hours is expected to be the maximum time frame for observing the advantage of increased bubble strength over bubble size. Likewise, bubble strength is expected to taper-off and reach a limit after a certain maturation time.

### Example 3

A further example was carried out in a similar manner to Example 2, in order to further explore the effect of maturation, as well as the effect of recirculation of coffee extract through the Megatron. Coffee extracts were prepared in the same way as described above for Example 2. The samples were passed to the Megatron and subjected to the following operating conditions shown in Table 7.

TABLE 7

| | | |
|---|---|---|
| Rotor speed | 3750 | rpm |
| Pump speed | 600 | rpm |
| Coffee flowrate | 52 | kg/h |
| Foaming | 20-25 | ° C. |
| temperature | | |

For this example, after baseline collection, the crystalliser was filled and extract held over a 3.5 hour maturation period between 0° C. and −5° C. Foamed extract was kept under light agitation (agitator speed=˜10 rpm) to prevent settling. All samples were taken after this maximum maturation time. References to maturation time include the time required to fill the crystalliser (˜35 mins). A one-off sample was produced which involved recirculating foamed extract through a second pass in the Megatron. In this case, no additional gas was input but the rotor speed and flowrate remained constant. Referred to as the ‘recirculation’ sample, this was collected at the static mixer outlet and frozen as per the baseline samples. Samples taken are shown in table 8 below.

TABLE 8

| | Maturation time | Time in PBC | |
|---|---|---|---|
| | (in crystalliser) | at −14° C. | Secondary |
| Sample | [hours] | [mins] | freezing method |
| Baseline-CR | 0 | 120 | Cold room |
| Baseline-BF | 0 | 120 | Blast freezer |
| Recirculation | 0 | 120 | Cold room |
| F0-CR | 3.5 | 0 | Cold room |
| F0-BF | 3.5 | 0 | Blast freezer |
| F30-CR | 3.5 | 30 | Cold room |
| F60-CR | 3.5 | 60 | Cold room |
| F90-CR | 3.5 | 90 | Cold room |
| F120-CR | 3.5 | 120 | Cold room |

Freezing profiles were based on that of the Example 2 where freezing involved an initial period of 2 h at around −12° C. to grow ice crystals. This was achieved by using the Polar blast freezer cabinets (PBCs). This profile was utilised for the baseline and recirculation samples.

For samples taken from the crystalliser post-maturation, the freezing profile was varied. Four samples were kept at −12° C. for varying lengths of time (30 mins, 60 mins, 90 mins and 120 mins respectively). A further 2 samples were taken post-maturation which were immediately cooled to −50° C. The rate of cooling here was varied via the use of the cold room and blast freezer respectively. After sufficient freezing, samples were ground, sifted and dried in Ray 1 as described for Example 2.

The same analyses that were performed in Example 2 were performed for Example 3 (i.e. foamed extract density, freezing profile analysis, BSD analysis, and crema analysis).

### Results

The foamed extract density and freezing profile analysis were assessed to analyse the trial validity.

### Bubble Size Distribution

BSD data was obtained via the use of the SOPAT probe at the static mixer outlet and crystalliser outlet respectively. The former location was used to study the two baseline and recirculation sample, which underwent no maturation. The latter location allowed the measurement of BSD after the full maturation period (3.5 h). The BSDs for these samples are given in FIG. 15. It should be noted that the measurement point was selected to show the state of bubbles directly before freezing.

As shown in FIG. 15, both baseline samples and the recirculation sample had near identical BSDs. All of which featured a characteristically dominant peak at around 18 μm and a smaller peak at around 22 μm. This level of similarity of BSD was expected for the two baseline samples as these were taken consecutively without changing aeration conditions. The recirculation sample had a very similar BSD to the baseline samples, which demonstrates a high level of repeatability in the Megatron.

FIG. 15 also shows that bubble size and size distribution grow vastly over the 3.5 hour maturation period. The distribution of the matured sample suggests significant ripening occurs as there is greater detection of bubbles less than 15 μm than the un-matured samples. This size decrease happens at the expense of an average increase in mean bubble size, which is shown in Table 9. The samples after 3.5 hour maturation had large volumetric mean bubble size, d_{4,3}, which was seen to be approximately double that of the un-matured samples. Moreover, standard deviation and variance increased by a factor of 3 and 15 respectively after maturation.

TABLE 9

| | Volume weighted | | |
|---|---|---|---|
| | mean size (De | Standard | |
| | Brouckere mean) | deviation | Variance |
| | d_{4, 3} | σ | Var |
| Sample | μm | μm | μm² |
| Baseline CR | 20.8 | 2.9 | 8.3 |
| Baseline BF | 20.6 | 2.8 | 7.9 |
| Recirculation | 20.2 | 2.5 | 6.4 |
| 3.5 h | 39.9 | 11.1 | 123.7 |
| Maturation | | | |

### Product Crema Analysis

This trial explored several processing methods which took place prior to freezing. The standard process is replicated by the baseline samples. The matured samples underwent 3.5 hour maturation period after the baseline aeration method. Finally, a recirculation method was tested wherein a sample was exposed to 2 passes in the Megatron.

FIG. 16 shows the final product crema quality from these different processing methods. The images are of samples whose freezing profiles are consistent and slow (2 h at ˜12° C. before moving to the cold room). As shown, the baseline or standard method was observed as having the lowest quality crema. Both the matured and recirculated samples produced high quality crema.

The trend of improved crema after maturation was expected and corroborates what was seen in Example 2. The improvement in crema quality after recirculating was an entirely new finding, although not surprising. Without wishing to be bound by theory, it is thought that recirculation improves the foam because while the rotor directly improves mass transfer, it also effectively reduces bubble size.

Such a recirculation method could be combined with the maturation step to provide an coffee product that forms improved crema.

Effect of Freezing Profile after Maturation

The sensitivity of matured extract foam to changing freezing profile was assessed. Several samples were taken after identical aeration and maturation steps. The method in which these samples were frozen was varied. The effect of freezing profile on crema after 3.5 h maturation is given in FIG. 17. As shown, crema was seen to improve when produced with gentler freezing profiles (longer time at −14° C.). This has been known for some time.

Promisingly, all samples produced decent crema, regardless of freezing profile. The first sample to make noticeably improved crema was produced after 60 mins at −14° C. These results suggest maturation may offer increased resilience to freezing fluctuations. While slow freezing remains best for crema quality, these matured samples were able to produce good crema at faster freezing conditions.

As used herein, the singular form of “a”, “an” and “the” include plural references unless the context clearly dictates otherwise. The use of the term “comprising” is intended to be interpreted as including such features but not excluding other features and is also intended to include the option of the features necessarily being limited to those described. In other words, the term also includes the limitations of “consisting essentially of” (intended to mean that specific further components can be present provided they do not materially affect the essential characteristic of the described feature) and “consisting of” (intended to mean that no other feature may be included such that if the components were expressed as percentages by their proportions, these would add up to 100%, whilst accounting for any unavoidable impurities), unless the context clearly dictates otherwise. Percentages are by weight, unless indicated to the contrary.

The foregoing detailed description has been provided by way of explanation and illustration, and is not intended to limit the scope of the appended claims. Many variations of the presently preferred embodiments illustrated herein will be apparent to one of ordinary skill in the art, and remain within the scope of the appended claims and their equivalents.

1. A method for the manufacture of a freeze-dried coffee powder, the method comprising:
(a) providing a coffee extract having from 40 wt % to 55 wt % solids;
(b) high-shear mixing the coffee extract in a rotor/stator aerator with added gas to form a foamed coffee extract, the gas being added in an amount of from 1 NL/kg to 5 NL/kg of coffee extract, wherein the rotor/stator aerator is maintained at a pressure of less than 2 bar and is configured to subject the coffee extract to a shear of from 7,500 to 20,000 s⁻¹ in a single pass having a residency time of at least 1 second,
(c) cooling the foamed coffee extract to below −40° C. without shear, or with low shear, to form a frozen coffee extract,
(d) grinding the frozen coffee extract to a powder; and
(e) drying the powder,
wherein the step (c) of cooling the foamed coffee extract to below −40° C. comprises:
(i) cooling the foamed coffee extract to a first temperature;
(ii) cooling the foamed coffee extract from the first temperature to a second temperature lower than the first temperature; and
(iii) cooling the foamed coffee extract from the second temperature to below −40° C.,
wherein the first temperature is 1° C. above a freezing point of the foamed coffee extract and wherein the second temperature is 3° C. below the freezing point,
wherein step (ii) has a duration of from 30 minutes to 5 hours, preferably 1 to 4 hours, and wherein the foamed coffee extract obtained in step (b) is maintained at a pressure of less than 2 bar until the frozen coffee extract is formed in step (c).

2. The method according to claim 1, wherein the coffee extract in the rotor/stator aerator is maintained at a pressure of from 1 to 1.8 Bar, preferably from 1 to 1.4 Bar.

3. The method according to claim 1, wherein the high shear mixing of the coffee extract is performed in a single pass, or two or more passes.

4. The method according to claim 1, wherein the coffee extract has a residency time in the rotor/stator aerator of at least 2 seconds in each pass, preferably, from 20 seconds to 2 minutes.

5. The method according to claim 1, wherein the low shear during cooling is less than 50 s⁻¹.

6. The method according to claim 1, wherein the gas is selected from nitrogen, air, argon, nitrous oxide and carbon dioxide, or a mixture of two or more thereof.

7. The method according to claim 1, wherein the step (i) of cooling the foamed coffee extract to a first temperature, comprises a step of holding the foamed coffee extract at a temperature more than 1° C. above, but no more than 15° C. above, a freezing point of the foamed coffee for a duration of from 30 minutes to 4 hours, optionally with low shear agitation,

8. A method of foaming a coffee extract, the method comprising foaming the coffee extract using a rotor/stator aerator before freeze-drying to increase the amount of crema formed on reconstitution of the freeze-dried coffee product.

9. A method for the manufacture of a foaming coffee powder, the method comprising:
providing an aqueous coffee extract having from 40 wt % to 60 wt % solids, preferably 40 to 55 wt % solids;
foaming the aqueous coffee extract to produce a foamed coffee extract having an average gas bubble size of less than 40 microns, preferably less than 20 microns;
holding the foamed coffee extract at a temperature more than 1° C. above, but no more than 15° C. above, a freezing point of the foamed coffee for a duration of from 30 minutes to 4 hours, optionally with low shear agitation, and
drying the foamed coffee extract to form a foaming coffee powder.

10. The method according to claim 9, wherein the step of drying the foamed coffee extract further comprises: (i) spray-drying the foamed coffee extract; or (ii) freeze-drying the foamed coffee extract.

11. The method according to claim 9, wherein the step of foaming the aqueous coffee extract is performed by:
(i) pressurising the aqueous coffee extract and adding gas; or
(ii) high-shear mixing the aqueous coffee extract in a rotor/stator aerator with added gas.

12. The method of claim 9, wherein the duration of the holding step is controlled to ensure that the average gas bubble size remains less than 40 microns, preferably less than 20 microns.

13. The method of claim 9, wherein the holding step comprises holding the cooled foamed coffee extract inside a crystalliser vessel at a temperature of from 0 to −5° C.

14. The method of claim 9, wherein the holding step comprises holding the cooled foamed coffee extract inside a crystalliser with an agitation speed of from 5 to 15 rpm, and preferably of from 8 to 12 rpm, and most preferably of approximately 10 rpm.

15. The method of claim 9, wherein the foamed coffee extract is subjected to two or more foaming passes before the holding step.

16. The method of claim 9, wherein the holding step comprises holding the foamed coffee extract inside the crystalliser for at least 30 minutes, preferably at least 60 minutes, more preferably at least 90 minutes, and most preferably at least 120 minutes.

17. The method according to claim 1, wherein the coffee extract:
(a) has from 40 to 45 wt % solids and wherein the freezing point is from −5 to −7° C.; or
(b) has from 45 to 50 wt % solids and wherein the freezing point is from −7 to −8° C.; or
(c) has from 50 to 55 wt % solids and wherein the freezing point is from −8 to −10° C.

18. The method according to claim 1, wherein the coffee extract has from 48 to 51 wt % solids.

19. The method according to claim 1, wherein the foamed coffee extract is at atmospheric pressure before the step of cooling and has a density of from 500 to 800 g/l.

20. A freeze-dried coffee powder obtainable by the method of claim 1.
